(19) United States
(12) Patent Application Publication
(10) Pub. No.: US 2012/0192640 A1
(43) Pub. Date: Aug. 2, 2012

(54) Borehole Imaging and Formation Evaluation While Drilling

(76) Inventors: Chanh Cao Minh, Katy, TX (US); Daniel Codazzi, Houston, TX (US); Ruben Martinez, Houston, TX (US); Roger Griffiths, Schaffhausen (CH); Kais B.M. Gzara, El-Menzah 9C (TN); Qiming Li, Sugar Land, TX (US); Colin Michael Sayers, Katy, TX (US); Reza Taherian, Sugar Land, TX (US)

(21) Appl. No.: 13/298,938

(22) Filed: Nov. 17, 2011

Related U.S. Application Data
(63) Continuation of application No. 11/421,945, filed on Jun. 2, 2006, now Pat. No. 8,162,076.

(51) Int. Cl. E21B 49/00; G01V 3/32; G01V 3/18

(52) U.S. Cl. 73/152.16; 73/152.02; 324/303

(57) ABSTRACT

A logging tool having a plurality of different sensor types having close spacings mounted on an articulated or extendible pad, a sleeve, a mandrel, a stabilizer, or some combination of those is provided and used to make measurements in a wellbore in a single logging run. Those measurements are used to create images of the wellbore and the images are used to deduce the local geology, optimize well placement, perform geomechanical investigation, optimize drilling operations, and perform formation evaluation. The logging tool includes a processor capable of making those measurements, creating those images, performing those operations, and making those determinations. The plurality of different sensors may be one or more resistivity sensors, dielectric sensors, acoustic sensors, ultrasonic sensors, caliper sensors, nuclear magnetic resonance sensors, natural spectral gamma ray sensors, spectroscopic sensors, cross-section capture sensors, and nuclear sensors, and they may be “plug-and-play” sensors.

### RELATED APPLICATIONS

This application is a Continuation-in-part of U.S. application Ser. No. 11/421,945, filed Jun. 2, 2006, entitled System And Method For Reducing The Borehole Gap For Downhole Formation Testing Sensors; the entire contents of which is incorporated herein by reference.

### BACKGROUND

Logging tools have long been used in wellbores to make, for example, formation evaluation measurements to infer properties of the formations surrounding the borehole and the fluids in the formations. Common logging tools include electromagnetic tools, nuclear tools, and nuclear magnetic resonance (NMR) tools, though various other tool types are also used.

Early logging tools were run into a wellbore on a wireline cable, after the wellbore had been drilled. Modern versions of such wireline tools are still used extensively. However, the need for information while drilling the borehole gave rise to measurement-while-drilling (MWD) tools and logging-while-drilling (LWD) tools. By collecting and processing such information during the drilling process, the driller can modify or correct key steps of the operation to optimize performance.

MWD tools typically provide drilling parameter information such as weight on the bit, torque, temperature, pressure, direction, and inclination. LWD tools typically provide formation evaluation measurements such as resistivity, porosity, and NMR distributions. MWD and LWD tools often have components common to wireline tools (e.g., transmitting and receiving antennas), but MWD and LWD tools must be constructed to not only endure but to operate in the harsh environment of drilling. The terms MWD and LWD are often used interchangeably, and the use of either term in this disclosure will be understood to include both the collection of formation and wellbore information, as well as data on movement and placement of the drilling assembly.

Logging tools can also be used to image a wellbore. For example, measurements of resistivity, density, the photoelectric factor, natural gamma ray radiation, the dielectric constant, and acoustic impedance (e.g., ultrasonics) have been used to form wellbore images. Most, if not all, of those imaging methods are dependent on the type of drilling fluid (“mud”) used.

### SUMMARY

A logging tool having a plurality of different sensor types having close spacings mounted on an articulated or extendible pad, a sleeve, a mandrel, a stabilizer, or some combination of those is provided and used to make measurements in a wellbore in a single logging run. Those measurements are used to create images of the wellbore and the images are used to deduce the local geology, optimize well placement, perform geomechanical investigation, optimize drilling operations, and perform formation evaluation. The logging, tool includes a processor capable of making those measurements, creating those images, performing those operations, and making those determinations. The plurality of different sensors may be one or more resistivity sensors, dielectric sensors, acoustic sensors, ultrasonic sensors, caliper sensors, nuclear magnetic resonance sensors, natural spectral gamma ray sensors, spectroscopic sensors, cross-section capture sensors, and nuclear sensors, and they may be “plug-and-play” sensors. This summary is provided to introduce a selection of concepts that are further described below in the detailed description. This summary is not intended to identify key or essential features of the claimed subject matter, nor is it intended to be used as an aid in limiting the scope of the claimed subject matter.

### FIGURES

Embodiments of a borehole imaging and formation evaluation logging-while-drilling tool are described with reference to the following figures. The same numbers are generally used throughout the figures to reference like features and components.

FIG. 1 illustrates a well site system.

FIG. 2 shows a prior art electromagnetic logging tool.

FIG. 3 shows an embodiment of a borehole imaging and formation evaluation logging-while-drilling tool, in accordance with the present disclosure.

FIG. 4 schematically shows acquisition and control electronics installed in a mandrel, in accordance with the present disclosure.

FIG. 5 schematically shows the mandrel of FIG. 4 with a neutron section, in accordance with the present disclosure.

FIG. 6 is a flowchart showing an embodiment in accordance with the present disclosure.

FIG. 7 is a flowchart showing an embodiment in accordance with the present disclosure.

FIG. 8 is a flowchart showing an embodiment in accordance with the present disclosure.

FIG. 9 is a flowchart showing an embodiment in accordance with the present disclosure.

FIG. 10 is a flowchart showing an embodiment in accordance with the present disclosure.

FIG. 11 is a flowchart showing an embodiment in accordance with the present disclosure.

FIG. 12 is a flowchart showing an embodiment in accordance with the present disclosure.

FIG. 13 is a flowchart showing an embodiment in accordance with the present disclosure.

FIG. 14 is a flowchart showing an embodiment in accordance with the present disclosure.

FIG. 15 is a flowchart showing an embodiment in accordance with the present disclosure.

FIG. 16 is a flowchart showing an embodiment in accordance with the present disclosure.

FIG. 17 is a flowchart showing an embodiment in accordance with the present disclosure.

FIG. 18 is a flowchart showing an embodiment in accordance with the present disclosure.

It should be understood that the drawings are not to scale and that the disclosed embodiments are sometimes illustrated diagrammatically and in partial views. In certain instances, details that are not necessary for an understanding of the disclosed method and apparatus or that would render other details difficult to perceive may have been omitted. It should be understood that this disclosure is not limited to the particular embodiments illustrated herein.

### DETAILED DESCRIPTION

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate.

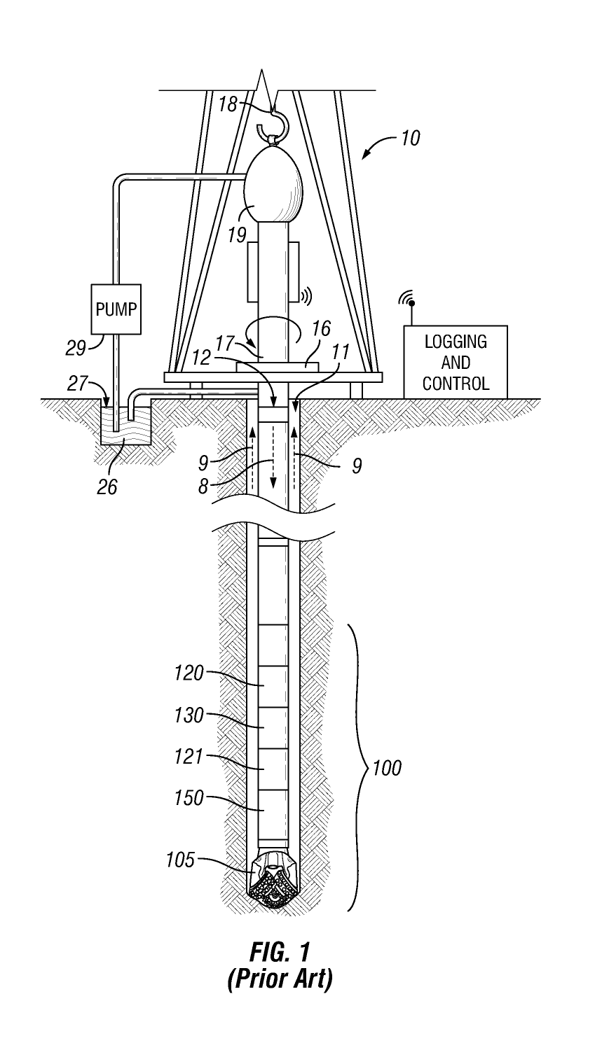

FIG. 1 illustrates a well site system in which various embodiments can be employed. The well site can be onshore or offshore. In this example system, a borehole 11 is formed in subsurface formations by rotary drilling in a manner that is well known. Some embodiments can also use directional drilling, as will be described hereinafter.

A drill string 12 is suspended within the borehole 11 and has a bottom hole assembly 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system could alternatively be used.

In the example of this embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

The bottom hole assembly 100 of the illustrated embodiment includes a logging-while-drilling (LWD) module 120, a measuring-while-drilling (MWD) module 130, a roto-steerable system and motor 150, and drill bit 105.

The LWD module 120 is housed in a special type of drill collar, as is known in the art, and can contain one or a plurality of known types of logging tools. It will also be understood that more than one LWD and/or MWD module can be employed, e.g. as represented at 121. (References, throughout, to a module at the position of 120 can alternatively mean a module at the position of 121 as well.) The LWD module includes capabilities for measuring, processing, and storing information, as well as for communicating with the surface equipment. In the present embodiment, the LWD module includes a resistivity measuring device.

The MWD module 130 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-hit measuring device, a torque measuring device, a vibration measuring device, a shock measuring device, a stick/slip measuring device, a direction measuring device, and an inclination measuring device.

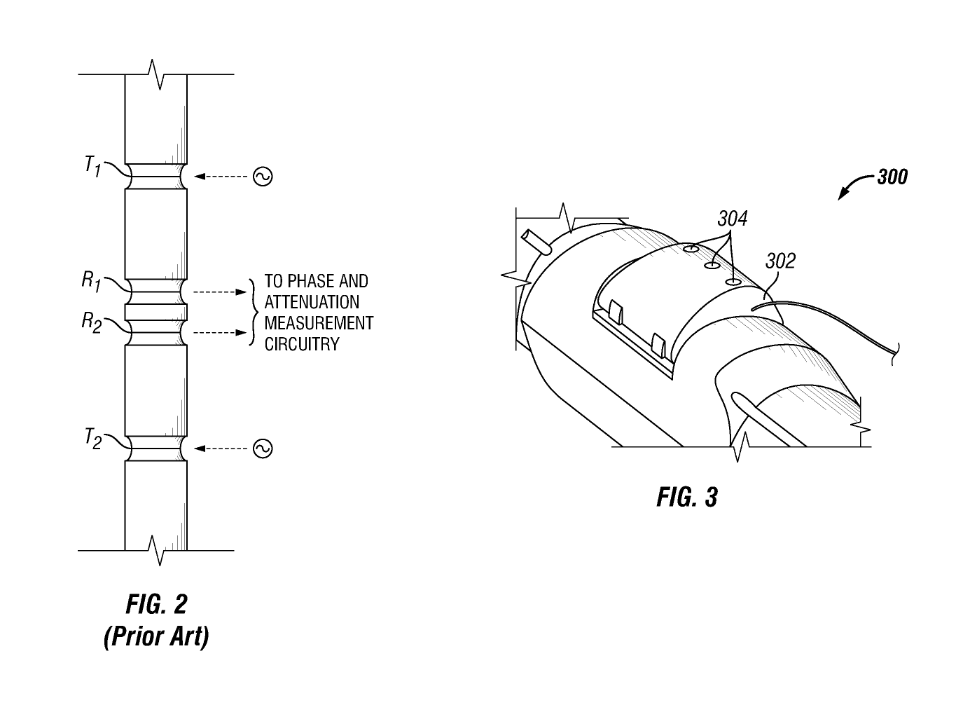

An example of a tool which can be the LWD tool 120, or can be a part of an LWD tool suite 121, is shown in FIG. 2. As seen in FIG. 2, upper and lower transmitting antennas, T₁ and T₂, have upper and lower receiving antennas, R₁ and R₂, therebetween. The antennas are formed in recesses in a modified drill collar and mounted in MC or insulating material. The phase shift of the electromagnetic wave between the receivers provides an indication of formation resistivity at a relatively shallow depth of investigation, and the attenuation of the electromagnetic wave between the receivers provides an indication of formation resistivity at a relatively deep depth of investigation. U.S. Pat. No. 4,899,112 can be referred to for further details. In operation, attenuation-representative signals and phase-representative signals are coupled to a processor, an output of which is coupleable to a telemetry circuit.

Recent electromagnetic (EM) logging tools use one or more tilted or transverse antennas, with or without axial antennas. Those antennas may be transmitters or receivers, A tilted antenna is one whose dipole moment is neither parallel nor perpendicular to the longitudinal axis of the tool. A transverse antenna is one whose dipole moment is perpendicular to the longitudinal axis of the tool, and an axial antenna is one whose dipole moment is parallel to the longitudinal axis of the tool. A triaxial antenna is one in which three antennas (i.e., antenna coils) are arranged to be mutually orthogonal. Often one antenna (coil) is axial and the other two are transverse. Two antennas are said to have equal angles if their dipole moment vectors intersect the tool's longitudinal axis at the same angle. For example, two tilted antennas have the same tilt angle if their dipole moment vectors, having their tails conceptually fixed to a point on the tool's longitudinal axis, lie on the surface of a right circular cone centered on the tool's longitudinal axis and having its vertex at that reference point. Transverse antennas obviously have equal angles of 90 degrees, and that is true regardless of their azimuthal orientations relative to the tool.

A method and tool to provide an image of a borehole while drilling is provided. Such an image can be used, for example, to ascertain the local geology; for well placement, for geomechanical investigation, and for drilling optimization. The method and tool can also be used for formation evaluation. The image may be of high resolution and may be obtained in various wellbore hole diameters. The tool and method do not depend on the type of drilling fluid (mud) used.

Most sensors provide better measurements when the standoff distance (distance from sensor to wellbore wall) is minimized. To minimize standoff, sensors may be deployed, for example, on extendible or articulated pads, or they may be placed on a fixed portion of a stabilizer such as near the outer periphery of a stabilizer blade. The sensors may also be mounted on a sleeve or mounted directly on a mandrel. Certain sensor types (e.g., microsonic sensors) are less sensitive to standoff distance than others, so the maximum acceptable standoff distance will depend on the type of measurement being made. In some cases the articulated pad may try to keep the sensor or set of sensors pressed up against the wellbore wall with the least pressure possible, while in other embodiments sensors are in fixed locations on a tool such that the sensors come near, but do not contact the wellbore wall. Minimal pressure from the articulated pad is used when the potential for wear or damage to the sensor is a concern. FIG. 3 shows an embodiment of a tool 300 having a hinged or articulated pad 302.

One or more sensors 304 and one or more sensor types can be used. The sensors may be interchangeable, or what is referred to as “plug-and-play” type sensors, in that they fit in all collar sizes, or are easily scalable to fit other tool sizes. The sensors may, for example, measure the dielectric constant, perform ultrahigh resistivity imaging using current measurements, perform oil-base mud imaging using voltage measurements, measure the variation of formation conductivity using microinduction, make microsonic or ultrasonic measurements, or make nuclear magnetic resonance measurements. Sensors may be placed according to their standoff needs, and various sensor types may be deployed on the same pad or otherwise proximate one another. Sensors of the same type may also be deployed to provide measurement redundancy. In addition, a sensor such as an angle encoder (not shown) may measure the articulation angle for hinged pad 302 to provide a mechanical caliper measurement.

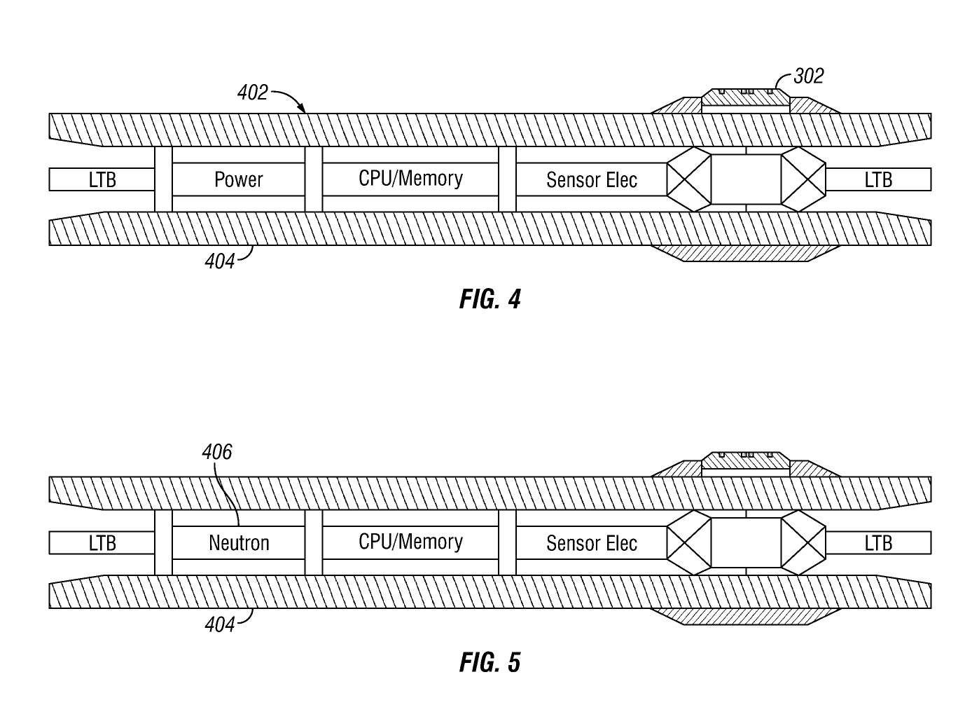

In the embodiment shown in FIG. 4, acquisition and control electronics 402 are installed in the interior region of a mandrel 404. The mandrels will generally be unique for different tool sizes, but not necessarily so. Generally, different sized tools require different collars and stabilizers, but not always. Data and power may be transmitted wirelessly or via wires between the mandrel 404 and, for example, the pad(s) 302. If desired, the electronics 402 in the pad 302 may be pressure compensated using, for example, an oil-filled ceramic multichip module. Measurement pad units may be optimized for (low) pixel size or measurement accuracy and depth of investigation. Angular orientation may be measured using, for example, magnetometers.

The mandrel 404 may also carry a neutron section 406 to extend its application to petrophysics and reservoir description (see FIG. 5). The neutron section 406 may comprise a pulsed neutron generator (PNG) fast neutron source, a neutron monitor (nm), and detectors distributed along the axis of the tool to capture variable source-to-detector spacing effects, such as lithology and environmental effects. The detector and measurement types may include, but are not limited to, at least 2× thermal neutron detectors (helium tubes) (including data acquisition in the time domain), epithermal neutron detectors (helium tubes) (including data acquisition in the time domain), at least 2× spectral gamma-ray detectors (including gated data acquisition and data acquisition in the time domain, and water-flow log type capability, if desired). Adequate shielding material for gamma arrays or neutrons may be provided to collimate the measurements.

The neutron section is totally scalable; that is, it is common to all (normal) tool sizes. Measurements may be single or multiple depths of investigation and may include the thermal neutron porosity, the best phi neutron porosity, pulsed neutron density, the cross section for absorption of thermal neutrons (i.e., capture cross section), and the thermal-neutron capture spectroscopy. The carbon oxygen ratio may be determined by performing a fast neutron inelastic scattering analysis.

A “single logging run” is meant to include one round trip of the logging platform in and out of a wellbore. Logging may occur while tripping in, while stationary within the wellbore, while tripping out, or any combination of those.

In one embodiment, all desired measurement types for geomechanical investigation may be included in a single platform. The combination of high resolution borehole images, hole size and hole shape measurements, stress anisotropy measurements, shale/rock evaluation, and clay-typing while drilling and in time-lapsed mode provides what is generally considered complete information for geological/geomechanical interpretation.

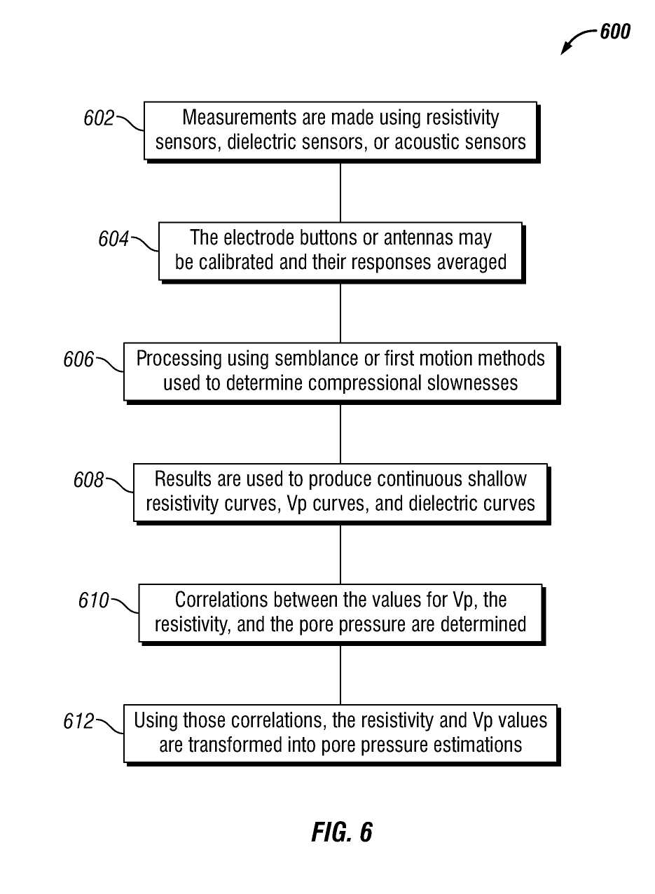

Two possible geomechanical applications are to determine pore pressure (600) (see FIG. 6) and to maintain wellbore stability. Measurements are made (602) using, for example, resistivity sensors, dielectric sensors, or acoustic sensors. As a specific example, resistivity sensors may be mounted, as described above, on a pad, on a sleeve, or directly on the tool mandrel. They may be electrode buttons or transmitting and receiving antennas. The resistivity buttons or antennas may be calibrated and their responses averaged (604). Dielectric properties are measured from the electromagnetic wave attenuation and phase shift, and processing using semblance or first motion methods can be used to determine compressional slownesses (606). Those results may be used to produce continuous shallow resistivity curves, compressional velocity (Vp) curves, and dielectric curves (608). Correlations between the values for the resistivity, the dielectric constants, and the pore pressure are determined (610). Those may vary by region or from one basin to another. Those correlations may be calibrated with downhole pressure measurements. Using those correlations, the resistivity and Vp values may be transformed into pore pressure curve estimations (612). Mud weight may be constrained between pore pressure and the fracture gradient to keep the wellbore stable.

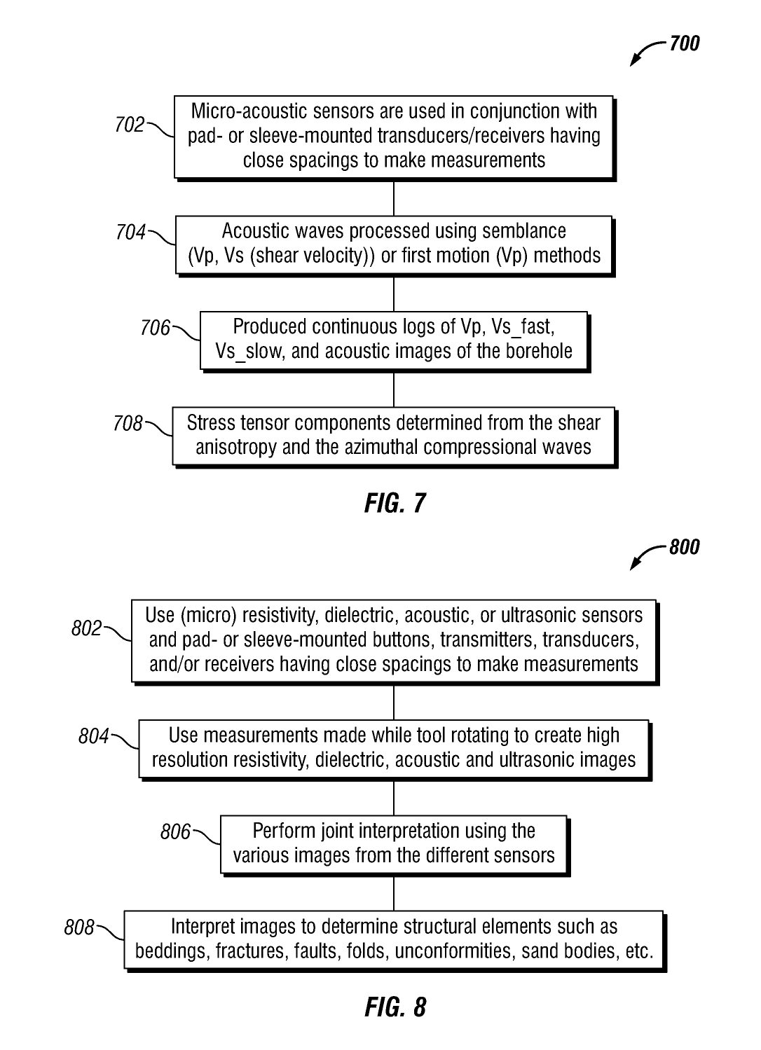

Another possible geomechanical application is to determine one or more components of the stress tensor for a formation (700), as shown in FIG. 7. Micro-acoustic sensors are used in conjunction with pad- or sleeve-mounted transducers/receivers having close spacings (702). Acoustic waves may be processed from semblance (Vp, Vs (shear velocity)) or first motion (Vp) methods (704). The close spacing and the rotating tool allow for wellbore imaging. Stresses in the formation can cause a shear wave to split into Vs_slow and Vs_fast components, and also can cause periodical variations of compressional Vp waves around the borehole. Continuous logs of Vp, Vs_fast, Vs_low, and acoustic images of the borehole may be produced (706). Stress may be determined from the shear anisotropy and the azimuthal compressional waves (708). Additionally, comparison with far-field Vp values allows for formation damage assessment.

in another embodiment, all desired measurement types for geological investigation may be included in a single platform. One may simultaneously (i.e., at the same time or during the same logging run) acquire the desired data, thereby enabling unsurpassed geological interpretation from all the images. Examples of desired data include a resistivity image for conductivity contrast, an acoustic image for impedance contrast, a microsonic image for compliance contrast, and a dielectric image for fluids contrast.

For a geological structural investigation (800) (FIG. 8), one may use (micro) resistivity, dielectric, acoustic, or ultrasonic sensors in conjunction with pad- or sleeve-mounted buttons, transmitters, transducers, and/or receivers having close spacings (802). The tool rotational movement allows for high resolution resistivity, dielectric, acoustic, and ultrasonic images (804). The processing workflow to produce those images can be done using existing commercial software. The joint interpretation (806) of the various images from the different sensors provides robustness to the determined structural events due to the different physical principles involved. Structural elements such as beddings, fractures, faults, folds, unconformities, sand bodies, etc. may be interpreted (808) from the images using certain characteristic features (e.g., low/high angle sinusoids, irregular surfaces, etc.).

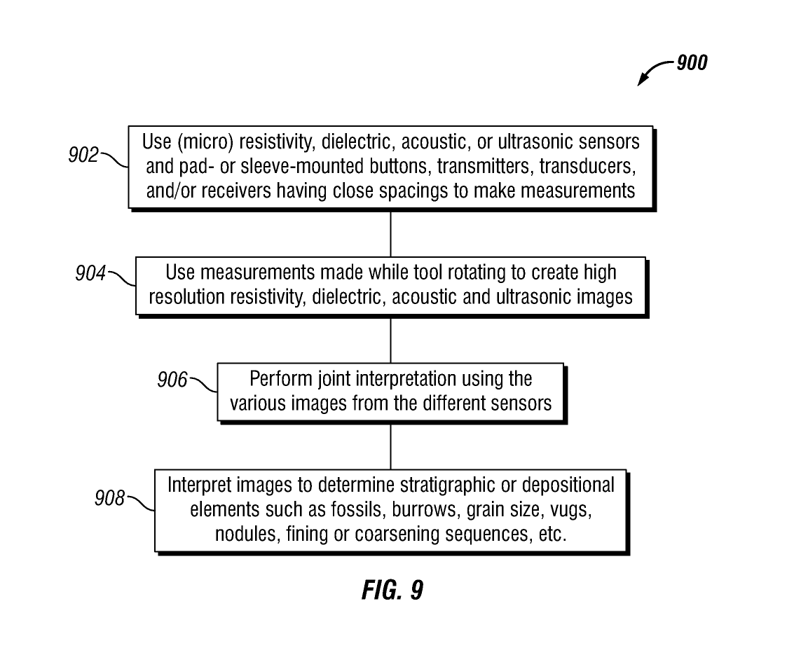

Similarly, for a geological stratigraphic, sedimentary, or fracture investigation (900) (FIG. 9), one may use (micro) resistivity, dielectric, acoustic, or ultrasonic sensors in conjunction with pad- or sleeve-mounted buttons, transmitters, transducers, and/or receivers having close spacings (902). The tool rotational movement allows for high resolution resistivity, dielectric, acoustic, and ultrasonic images (904). The processing workflow to produce those images can be done using existing commercial software. The joint interpretation (906) of the various images from the different sensors provides robustness to the determined depositional environment, paleontological sediments flow direction, and fracture evaluation (such as density, porosity, orientation, etc.) due to the different physical principles involved. Stratigraphic or depositional elements such as fossils, burrows, grain size, vugs, nodules, fining or coarsening sequences, etc. may be interpreted (908) from the images using certain characteristic features (e.g., shape, distribution, position, etc.).

Another embodiment includes all desired imaging and clay-typing technology and multi-arm caliper measurements in a single tool. The combination of high resolution borehole images and hole size and hole shape while drilling and in time-lapsed mode enable allows for estimation of borehole damage and stress unloading during drilling. Being able to perform clay-typing while drilling allows an operator to avoid, for example, the hazard of drilling into the overpressured zones associated with smectite to illite transformation.

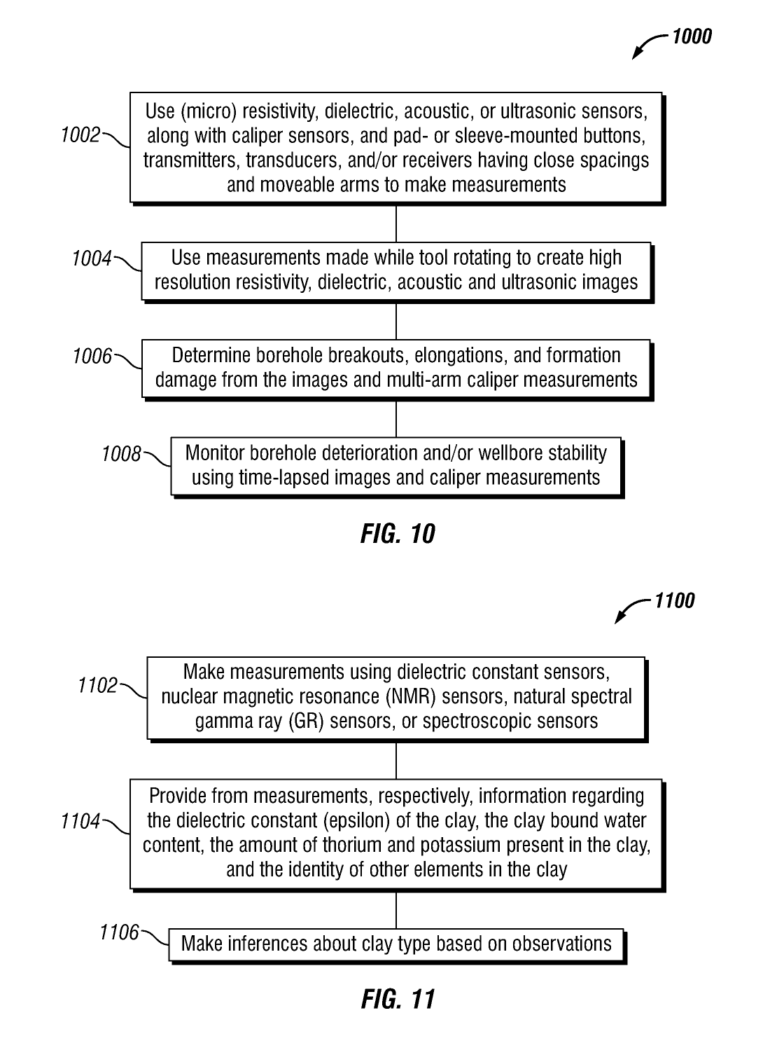

To determine borehole size and shape (1000) (FIG. 10), (micro) resistivity, dielectric, acoustic, and ultrasonic sensors, along with caliper sensors, may be used in conjunction with pad- or sleeve-mounted buttons, transmitters, transducers, and/or receivers having close spacings and moveable arms (1002). The tool rotational movement allows for high resolution resistivity, dielectric, acoustic, and ultrasonic images (1004). Arms or articulated pads opening and closing move a potentiometer that is calibrated to hole diameter. The processing workflow to produce those images from that data can be done using existing commercial software. Borehole breakouts, elongations, and formation damage can be studied from the images and multi-arm caliper measurements (1006). Time-lapsed images and caliper measurements allow one to monitor borehole deterioration and, to some extent, wellbore stability.

For clay-typing (1100) (FIG. 11), one may use, for example, dielectric constant sensors, nuclear magnetic resonance (NMR) sensors, natural spectral gamma ray (GR) sensors, or spectroscopic sensors (1102). Those sensors may provide, respectively, information regarding the dielectric constant (epsilon) of the clay, the clay bound water content, the amount of thorium and potassium present in the clay, and the identity of other elements in the clay (1104). Certain inferences about clay type may be made based on observations such as an increase in epsilon implying an increase in surface area of the clay, the clay bound water being directly linked to cation exchange capacity (CEC) (Qv), the thorium and potassium ratio (direct indicator of clay type), and the spectroscopy elements being reconstituted to give total clay composition (1106). Thus, the clay type may be determined from measurements that are sensitive to its surface area, the CEC, the magnetic properties, and the mineralogy.

in another embodiment, all desired measurement types for formation evaluation may be included in a single platform. One may simultaneously (i.e., at the same time or during the same logging run) acquire the desired data, thereby enabling formation evaluation even under difficult conditions. Examples of desired data include (micro) resistivity dielectric, density, neutron, GR, spectroscopy, microsonic and NMR measurements. Useful information may be had when measurements are made pre-invasion (i.e., while drilling) or post-invasion while tripping or reaming.

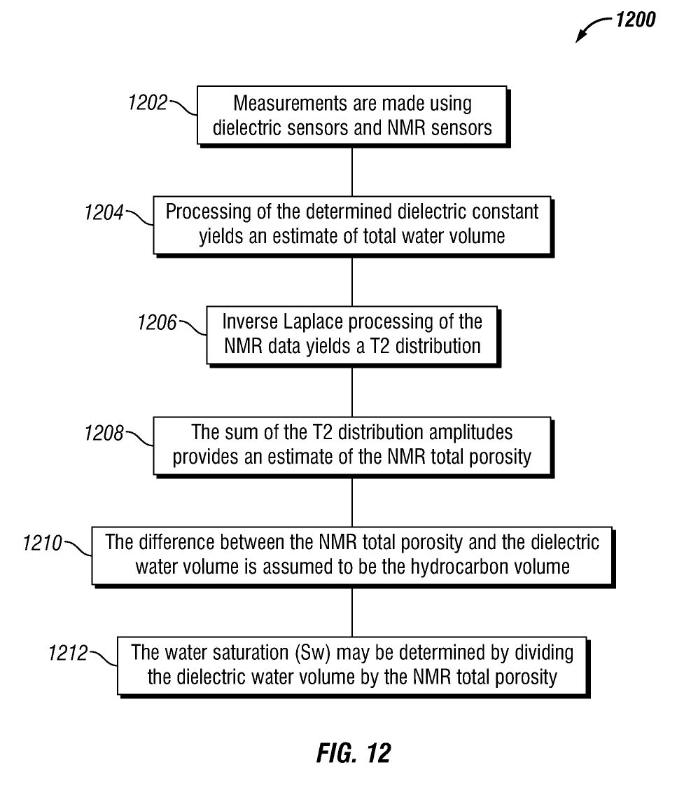

For example, porosity and water saturation may be determined independent of water salinity (1200) (FIG. 12). Measurements are made using dielectric sensors and NMR sensors (1202). The dielectric constant (epsilon) of the formation is determined from the dielectric measurements, and echo trains are recorded from the NMR measurements. The measurements may be taken while drilling to minimize invasion effects. Processing of the determined dielectric constant yields an estimate of total water volume (1204), and inverse Laplace processing of the NMS data yields a T2 distribution (1206). The sum of the T2 distribution amplitudes provides an estimate of the NMR total porosity (1208). The difference between the NMR total porosity and the dielectric water volume is assumed to be the hydrocarbon volume (1210). The water saturation (Sw) may be determined by dividing the dielectric water volume by the NMR total porosity (1212).

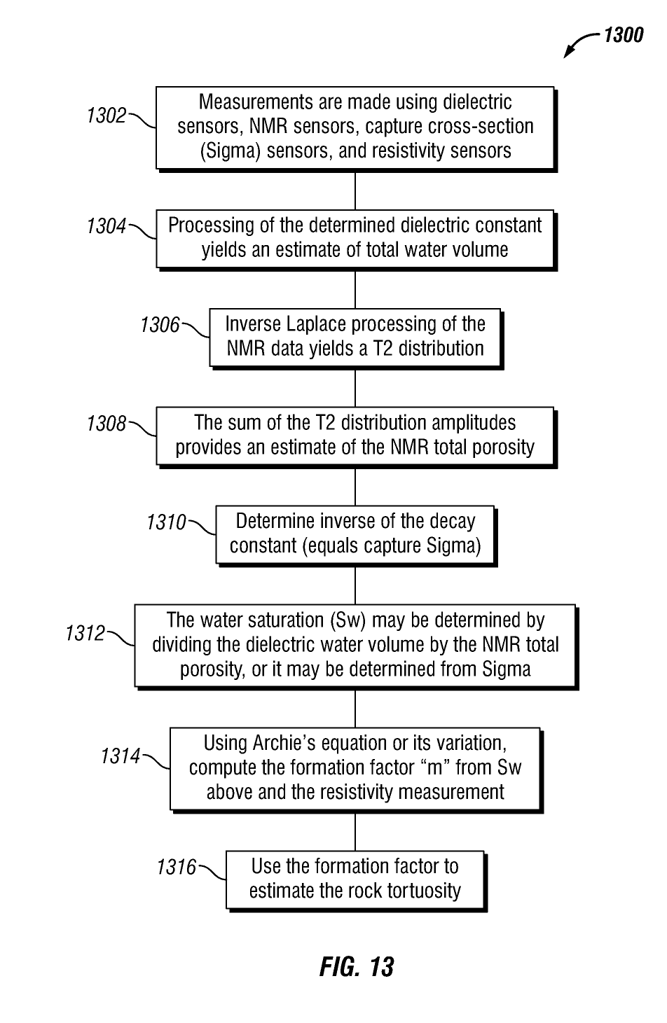

A further example involves determining the formation factor and using that factor to determine the rock tortuosity (1300) (FIG. 13). As above, measurements are made using dielectric sensors and NMR sensors, but also capture cross-section (Sigma) sensors and resistivity sensors (1302). The dielectric constant (epsilon) of the formation is determined from the dielectric measurements, the echo trains are recorded from the NMR measurements, and the capture cross-section measurements measure the neutron decay time curve. Processing of the determined dielectric constant yields an estimate of total water volume (1304), and inverse Laplace processing of the NMR data yields a T2 distribution (1306). The sum of the T2 distribution amplitudes provides an estimate of the NMR total porosity (1308). The inverse of the decay constant is the capture Sigma (1310). The water saturation (Sw) may be determined by dividing the dielectric water volume by the NMR total porosity, or it may be determined from Sigma (1312). Using Archie's equation or its variation, one may compute the formation factor “m” from Sw above and the resistivity measurement (1314). The formation factor is used to estimate the rock tortuosity (1316).

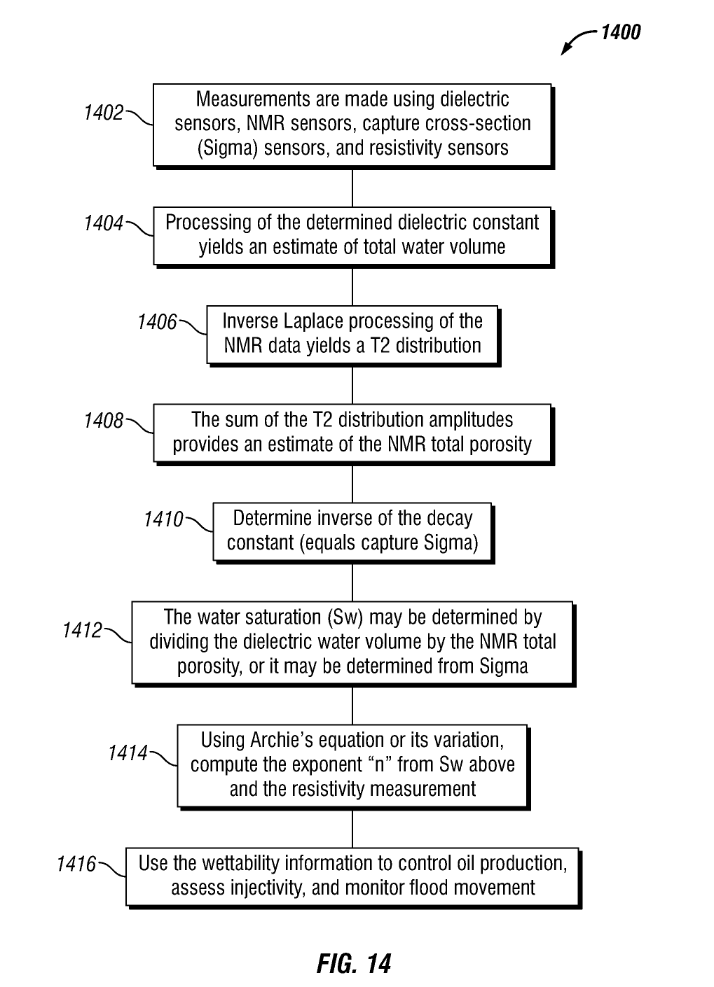

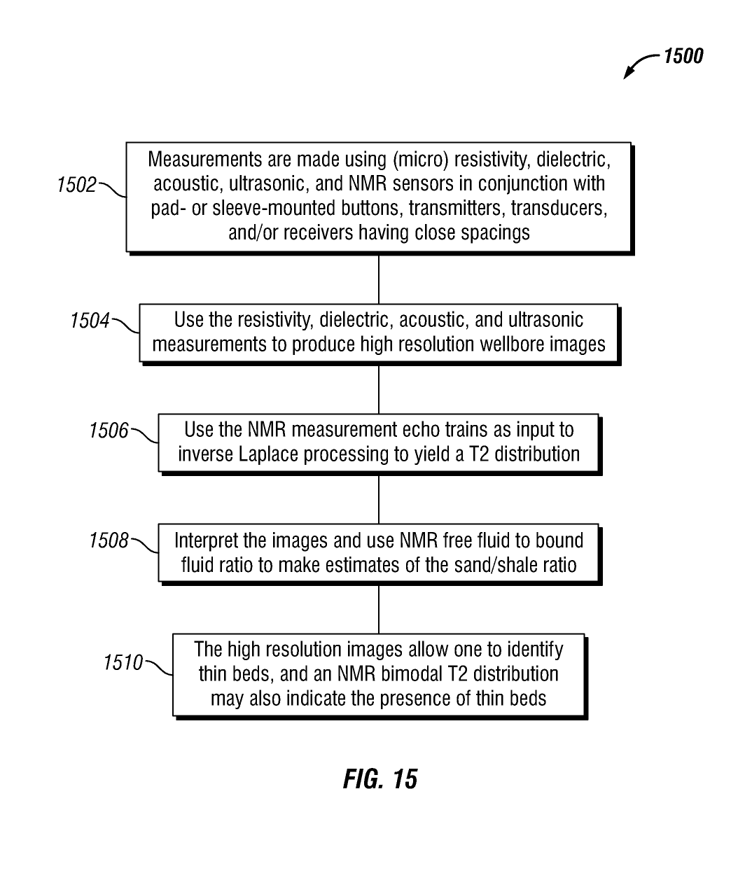

Similarly, wettability can be determined (1400) (FIG. 14) using those types of measurements. As above, measurements are made using dielectric sensors, NMR sensors, capture cross-section (Sigma) sensors, and resistivity sensors (1402). The dielectric constant (epsilon) of the formation is determined from the dielectric measurements, the echo trains are recorded from the NMR measurements, and the capture cross-section measurements measure the neutron decay time curve. Processing of the determined dielectric constant yields an estimate of total water volume (1404), and inverse Laplace processing of the NMR data yields a T2 distribution (1406). The sum of the T2 distribution amplitudes provides an estimate of the NMR total porosity (1408). The inverse of the decay constant is the capture Sigma (1410). The water saturation (Sw) may be determined by dividing the dielectric water volume by the NMR total porosity, or it may be determined from Sigma (1412). Using Archie's equation or its variation, one may compute the exponent “n” from Sw above and the resistivity measurement (1414). If n is greater than 2, then an oil-wet or mixed-wet condition is suspected. Alternatively, if the bulk oil T2 distribution is greater than the oil T2 distribution, that may indicate a surface relaxation effect, that is, an oil-wet or mixed-wet condition. Wettability information may be used to control oil production, assess injectivity, and monitor flood movement (1416).

An alternative formation evaluation embodiment to locate thin beds (1500) uses (micro) resistivity, dielectric, acoustic, ultrasonic, and NMR sensors in conjunction with pad- or sleeve-mounted buttons, transmitters, transducers, and/or receivers having close spacings (1502). An NMR short-length antenna may serve as a measurement sensor. The resistivity, dielectric, acoustic, and ultrasonic measurements can yield high resolution wellbore images (1504). The NMR measurements provide echo trains from which inverse Laplace processing yields a T2 distribution (1506). Interpretation of the images gives an estimate of the sand/shale ratio, as does the NMR free fluid to bound fluid ratio (1508). The high resolution images allow one to identify thin beds, and an NMR bimodal T2 distribution may also indicate the presence of thin beds (1510).

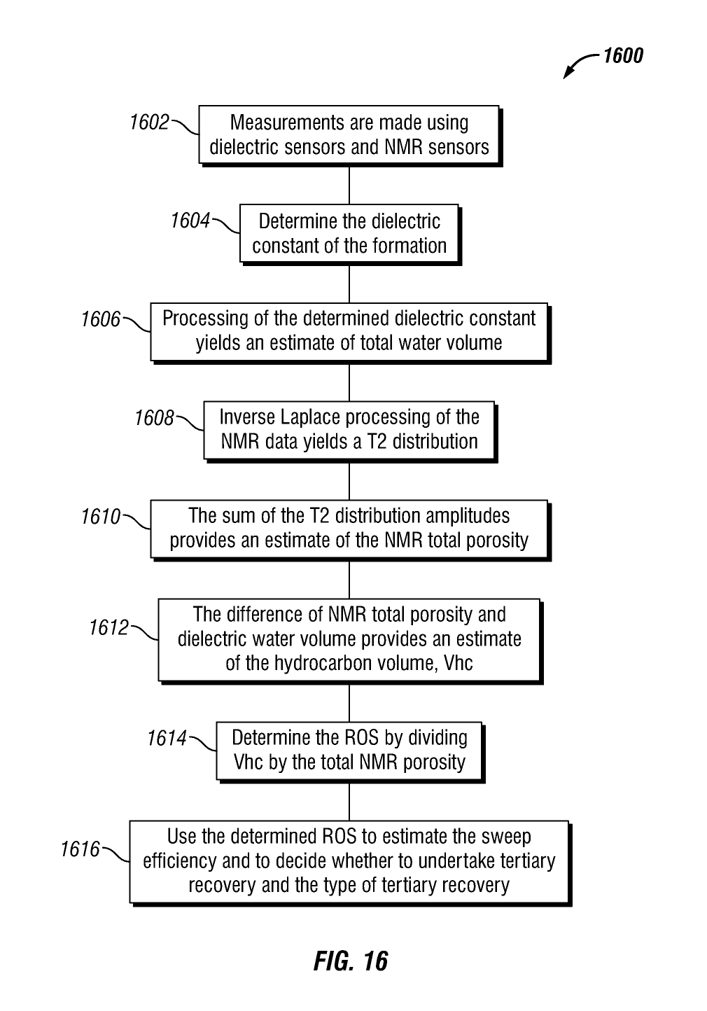

A further formation evaluation embodiment allows for the estimation of residual oil saturation (ROS) (1600) (FIG. 16). Dielectric sensors and NMR sensors may be used (1602) to determine the dielectric constant of the formation and a T2 distribution (1604). Measurements may be taken while tripping out or while reaming to maximize invasion in a carefully planned drilling. Alternatively, measurements may be made while drilling to minimize invasion in an observation well behind a flood front. As described above, processing of the determined dielectric constant yields an estimate of total water volume (1606), and inverse Laplace processing of the NMR data yields a T2 distribution (1608). The sum of the T2 distribution amplitudes provides an estimate of the NMR total porosity (1610). The difference of NMR total porosity and dielectric water volume provides an estimate of the hydrocarbon volume, Vhc (1612). The ROS may be determined by dividing Vhc by the total NMR porosity (1614). Alternatively, the ROS equals 1−Sw, where Sw is computed from Sigma if a capture cross-section measurement is made. The determined ROS may be used to estimate the sweep efficiency and to decide whether to undertake tertiary recovery and the type of tertiary recovery (1616).

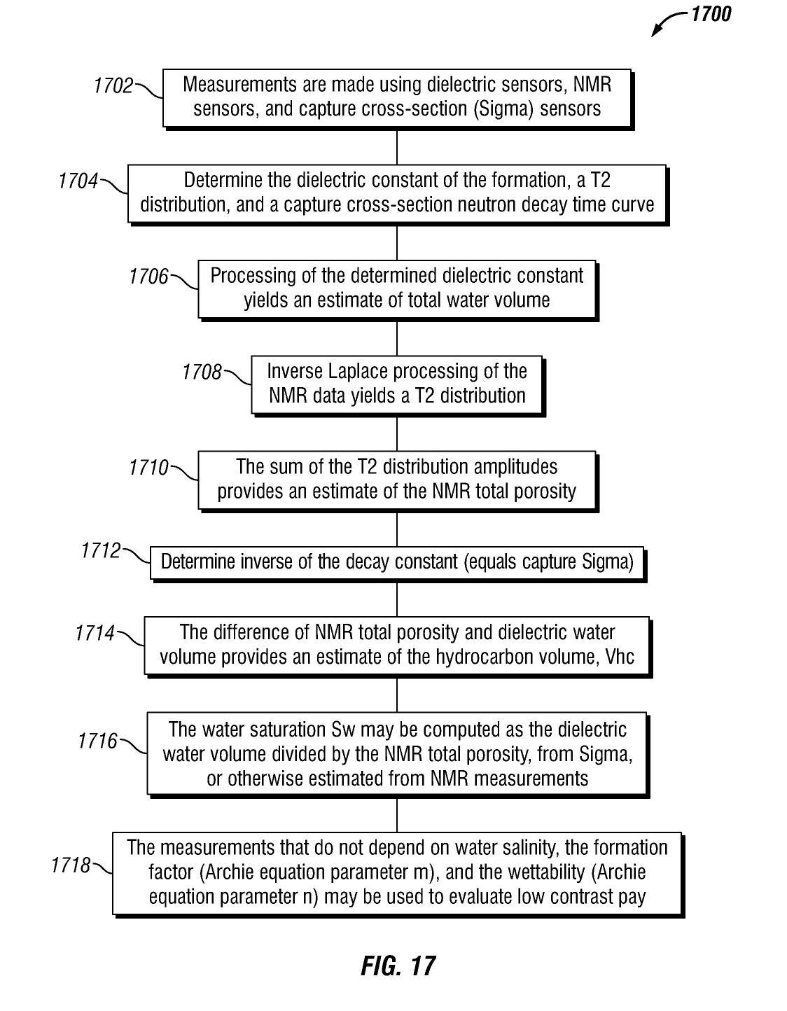

A further formation evaluation embodiment allows for the evaluation of low contrast pay (1700) (FIG. 17). Dielectric sensors, NMR sensors, and capture cross-section (Sigma) sensors may be used (1702) to determine the dielectric constant of the formation, a T2 distribution, and a capture cross-section neutron decay time curve (1704). As described above, processing of the determined dielectric constant yields an estimate of total water volume (1706), and inverse Laplace processing of the NMR data yields a T2 distribution (1708). The sum of the T2 distribution amplitudes provides an estimate of the NMR total porosity (1710). The inverse of the decay constant is the capture sigma (1712). The difference of NMR total porosity and dielectric water volume provides an estimate of the hydrocarbon volume, Vhc (1714). An NMR T2 distribution from water can be different from an NMR T2 distribution from hydrocarbons. Also, the water saturation derived from Sigma could indicate pay when the Archie equation parameters m and n obscure the water saturation interpretation from resistivity measurements. The water saturation Sw may be computed as the dielectric water volume divided by the NMR total porosity, from Sigma, or otherwise estimated from NMR measurements (1716). The measurements that do not depend on water salinity, the formation factor (Archie equation parameter m), and the wettability (Archie equation parameter n) may be used to evaluate low contrast pay (1718).

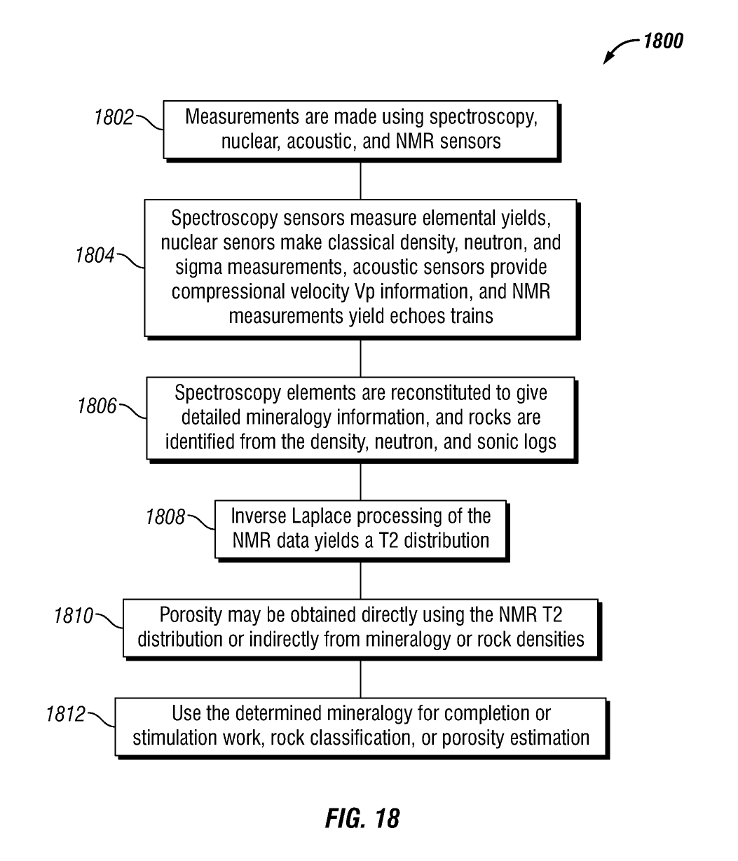

A further formation evaluation embodiment allows for the evaluation of complex lithology (1800) (FIG. 18). Spectroscopy, nuclear, acoustic, and NMR sensors may be used (1802) to make measurements. Spectroscopy sensors measure elemental yields, nuclear sensors make classical density, neutron, and sigma measurements, acoustic sensors provide compressional velocity Vp information, and NMR measurements yield echoes trains (1804). Spectroscopy elements are reconstituted to give detailed mineralogy information, and rocks are identified from the density, neutron, and sonic logs (1806). Inverse Laplace processing of NMR data yields a T2 distribution (1808). Porosity may obtained directly using the NMR T2 distribution or indirectly from mineralogy or rock densities (1810). The sum of the T2 distribution amplitudes gives NMR total porosity. The rock matrix density may be computed from the mineralogy and the density porosity may be derived from the density measurement. The determined mineralogy may be used, for example, for completion or stimulation work, rock classification, or porosity estimation (1812).

Advanced formation fluid typing and saturation interpretation under a variety of scenarios commonly encountered in practice is possible using one or more combinations of the measurements discussed. Some of those analyses may exploit time-lapse data acquisition. For example, one may determine, in wells drilled with either water-base mud or oil-base mud, variable water salinity, low salinity, unknown salinity, or the presence of low-resistivity-pay. Those analysis techniques may also apply to other scenarios in which conventional deep-reading resistivity techniques break down (e.g., high-angle wells or wells with significant bed-boundary effects). The measurements will generally be azimuthal and measurements from various measurement types may be combined to allow for further interpretation.

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

1. A method, comprising:
providing a logging tool having a plurality of different sensor types having close spacings mounted on an articulated or extendible pad, a sleeve, a mandrel, a stabilizer, or some combination of those;
making measurements using the plurality of different sensor types in a single logging run in a wellbore;
creating one or more images of the wellbore using the measurements;
using the one or more images of the wellbore to do one or more of deducing the local geology, optimizing well placement, performing geomechanical investigation, optimizing drilling operations, and performing formation evaluation.

2. The method of claim 1, wherein one or more of the sensors are “plug-and-play” sensors.

3. The method of claim 1, wherein the plurality of different sensor types includes resistivity sensors, dielectric sensors, and/or acoustic sensors and the sensors of a particular type are calibrated and their responses are averaged, and further comprising:
determining compressional slownesses by processing the measurements using semblance or first motion methods;
producing continuous shallow resistivity curves, Vp curves, and dielectric curves using the processing results;
determining correlations between the values for Vp, the resistivity, and the pore pressure; and
transforming the resistivity and Vp values into pore pressure estimations using those correlations.

4. The method of claim 1, wherein the plurality of different sensors includes micro-acoustic sensors and pad-mounted or sleeve-mounted transducers or receivers, and further comprising:
processing the measured acoustic waves using semblance or first motion methods; producing continuous logs of Vp, Vs_fast, Vs_slow, and acoustic images of the wellbore; and
determining stress tensor components from shear anisotropy and azimuthal compressional waves.

5. The method of claim 1, wherein the plurality of different sensors includes resistivity, dielectric, acoustic, and/or ultrasonic sensors and pad-mounted or sleeve-mounted buttons, transmitters, transducers, and/or receivers, and wherein the one or more images include high resolution resistivity, dielectric, acoustic, and ultrasonic images created from data obtained while the logging tool was rotating, and further comprising:
performing joint interpretation using the various high resolution images; and
determining geological structural elements using the joint interpretation.

6. The method of claim 1, wherein the plurality of different sensors includes resistivity, dielectric, acoustic, and/or ultrasonic sensors and pad-mounted or sleeve-mounted buttons, transmitters, transducers, and/or receivers, and wherein the one or more images include high resolution resistivity, dielectric, acoustic, and ultrasonic images created from data obtained while the logging tool was rotating, and further comprising:
performing joint interpretation using the various high resolution images; and
determining stratigraphic or depositional elements using the joint interpretation.

7. The method of claim 1, wherein the plurality of different sensors includes resistivity, dielectric, acoustic, ultrasonic, and/or caliper sensors and pad-mounted or sleeve-mounted buttons, transmitters, transducers, and/or receivers, and moveable arms, and wherein the one or more images include time-lapsed high resolution resistivity, dielectric, acoustic, and ultrasonic images created from data obtained while the logging tool was rotating, and further comprising:
determining borehole breakouts, elongations, and formation damage using the high resolution images and measurements from the caliper sensors; and
monitoring borehole deterioration and/or wellbore stability using the time-lapsed high resolution images and the caliper measurements.

8. The method of claim 1, wherein the plurality of different sensors includes dielectric, nuclear magnetic resonance (NMR), natural spectral gamma ray, and/or spectroscopic sensors, and the measurements include measurements made on a clay formation, and further comprising:
determining the dielectric constant of the clay, the clay bound water content, the amount of thorium and potassium present in the clay, and the identity of other elements in the clay using the measurements; and
making inferences about the clay type based on the determined quantities.

9. The method of claim 1, wherein the plurality of different sensors includes dielectric and nuclear magnetic resonance (NMR) sensors, and further comprising:
estimating a dielectric water volume by performing processing on a dielectric constant determined from the dielectric sensor measurements;
determining a T2 distribution by performing inverse Laplace processing of the NMR sensor measurements;
estimating the NMR total porosity using the sum of the T2 distribution amplitudes;
determining a hydrocarbon volume by taking the difference between the NMR total porosity and the dielectric water volume; and
determining a water saturation by dividing the dielectric water volume by the NMR total porosity.

10. The method of claim 1, wherein the plurality of different sensors includes resistivity, dielectric, nuclear magnetic resonance (NMR), and cross-section capture sensors, and further comprising:
estimating a dielectric water volume by performing processing on a dielectric constant determined from the dielectric sensor measurements;
determining a T2 distribution by performing inverse Laplace processing of the NMR sensor measurements;
estimating the NMR total porosity using the sum of the T2 distribution amplitudes;
determining the inverse of the decay constant using the cross-section capture sensor measurements;
determining a water saturation by dividing the dielectric water volume by the NMR total porosity or using the determined inverse of the decay constant;
computing a formation factor using the determined water saturation and the resistivity sensor measurements; and
determining the rock tortuosity using the determined formation factor.

11. The method of claim 1, wherein the plurality of different sensors includes resistivity, dielectric, nuclear magnetic resonance (NMR), and cross-section capture sensors, and further comprising:
estimating a dielectric water volume by performing processing on a dielectric constant determined from the dielectric sensor measurements;
determining a T2 distribution by performing inverse Laplace processing of the NMR sensor measurements;
estimating the NMR total porosity using the sum of the T2 distribution amplitudes;
determining the inverse of the decay constant using the cross-section capture sensor measurements;
determining a water saturation by dividing the dielectric water volume by the NMR total porosity or using the determined inverse of the decay constant;
computing an exponent used in Archie's equation using the determined water saturation and the resistivity sensor measurements;
determining a formation wettability; and
use the determined wettability to control oil production, assess infectivity, and monitor flood movement.

12. The method of claim 1, wherein the plurality of different sensors includes resistivity, dielectric, acoustic, ultrasonic, and/or nuclear magnetic resonance sensors and pad-mounted or sleeve-mounted buttons, transmitters, transducers, and/or receivers, and wherein the one or more images include high resolution resistivity, dielectric, acoustic, and ultrasonic images created from data obtained while the logging tool was rotating, and further comprising:
determining a T2 distribution by performing inverse Laplace processing of the NMR sensor measurements;
estimating a sand/shale ratio by interpreting the images and using a determined NMR free fluid to bound fluid ratio; and
determining the presence of thin beds using the high resolution images and/or an NMR bimodal T2 distribution.

13. The method of claim 1, wherein the plurality of different sensors includes dielectric and nuclear magnetic resonance (NMR) sensors, and further comprising:
determining a dielectric constant using the dielectric sensor measurements;
estimating a dielectric water volume by performing processing on the determined dielectric constant;
determining a T2 distribution by performing inverse Laplace processing of the NMR sensor measurements;
estimating the NMR total porosity using the sum of the T2 distribution amplitudes;
determining a hydrocarbon volume by taking the difference between the NMR total porosity and the dielectric water volume;
determine a residual oil saturation (ROS) by dividing the hydrocarbon volume by the total NMR porosity; and
estimating a sweep efficiency using the determined ROS.

14. The method of claim 13, further comprising deciding whether to undertake tertiary recovery and the type of tertiary recovery.

15. The method of claim 1, wherein the plurality of different sensors includes dielectric, nuclear magnetic resonance (NMR), and cross-section capture sensors, and further comprising:
estimating a dielectric water volume by performing processing on a dielectric constant determined from the dielectric sensor measurements;
determining a T2 distribution by performing inverse Laplace processing of the NMR sensor measurements;
estimating the NMR total porosity using the sum of the T2 distribution amplitudes;
determining a capture cross-section neutron decay time curve using the cross-section capture sensor measurements;
determining the inverse of the decay constant using the cross-section capture sensor measurements;
determining a hydrocarbon volume by taking the difference between the NMR total porosity and the dielectric water volume;
determining a water saturation by dividing the dielectric water volume by the NMR total porosity, by using the determined inverse of the decay constant, or otherwise estimating from the NMR sensor measurements; and
evaluating low contrast pay using measurements that do not depend on water salinity.

16. The method of claim 15, wherein the measurements that do not depend on water salinity include the formation factor (Archie equation parameter m), and the wettability (Archie equation parameter n).

17. The method of claim 1, wherein the plurality of different sensors includes nuclear magnetic resonance (NMR), nuclear, acoustic, and spectroscopic sensors, and the spectroscopy sensors measure elemental yields, the nuclear sensors make density, neutron, and sigma measurements, the acoustic sensors provide compressional velocity (Vp) information, and NMR measurements yield echoes trains, and further comprising:
reconstituting the spectroscopy identified elements to provide mineralogy information;
identifying rock formations using the density, neutron, and sonic measurements;
determining a T2 distribution by performing inverse Laplace processing of the NMR sensor measurements;
obtaining the porosity using the NMR T2 distribution, from the mineralogy information, or determined rock densities; and
using the determined mineralogy information to make decisions regarding completion or stimulation work, for rock classification, or for porosity estimation.

18. A logging tool, comprising:
a plurality of different sensor types having close spacings mounted on an articulated or extendible pad, a sleeve, a mandrel, a stabilizer, or some combination of those; and
a processor capable of making measurements using the plurality of different sensor types in a single logging run in a wellbore; creating one or more images of the wellbore using the measurements; and using the one or more images of the wellbore to do one or more of deducing the local geology, optimizing well placement, performing geomechanical investigation, optimizing drilling operations, and performing halation evaluation.

19. The logging tool of claim 18, wherein the plurality of different sensors are selected from the group consisting of resistivity sensors, dielectric sensors, acoustic sensors, ultrasonic sensors, caliper sensors, nuclear magnetic resonance sensors, natural spectral gamma ray sensors, spectroscopic sensors, cross-section capture sensors, and nuclear sensors.

20. The logging tool of claim 18, wherein the plurality of different sensors are “plug-and-play” sensors.
